(19) United States
(12) Patent Application Publication
(10) Pub. No.: US 2003/0077944 A1
(43) Pub. Date: Apr. 24, 2003

(54) Connecting device

(76) Inventors: Wen-Kuan Lin, Taipei (TW); Chien-Chih Chen, Taipei Hsien (TW); Hui-Min Chu, Taipei Hsien (TW)

Correspondence Address: BIRCH STEWART KOLASCH & BIRCH, PO BOX 747, FALLS CHURCH, VA, 22040-0747, US

(21) Appl. No.: 09/983,257

(22) Filed: Oct. 23, 2001

(51) Int. Cl. H01R 25/00; H01R 27/02; H01R 31/00; H01R 33/88; H01R 33/90; H01R 33/92; H01R 33/94

(52) U.S. Cl. 439/638

(57) ABSTRACT

The invention discloses a connecting device installed on an external peripheral device for connecting the external peripheral device with mobile phones or PDAs that have different connection port specifications. The invention provides a connection base and a connector. The connection base is disposed on the external peripheral device and the connector is selected according to the connection port specifications of the accompanying electronic device. The connector connects the connection ports of the connection base and the electronic device, forming electrical communication between the connection base and the electronic device. This provides a wide variety of applications for external peripheral devices.

### BACKGROUND OF THE INVENTION

1. Field of the Invention

The invention relates to a connecting device for electronic devices such as mobile phones or PDAs(Personal Digital Assistants) that need external peripheral devices such as keyboards. More particularly, the invention relates to extending the applications' external peripheral devices so to as to form electrical communications with different electronic devices.

2. Related Art

With the emergence of the concept of portable digital information devices, products such as notebook PC's and hand-held PC's have been invented to replace desktop computers. However, such devices do not completely satisfy the needs of portable digital information devices. Smaller sized mobile phones and PDAs have been invented to provide more convenience to users.

Taking mobile phones or PDAs as an example, their volumes are becoming smaller while more functions are offered. However, the size of the keypads must be decreased as the volume decreases. For example, normally there are at least the 0˜9, #, and * keys on a mobile phone. When the size of the mobile phone is reduced, the distance between the keys also decreases. Therefore, it becomes inconvenient for users to press the keys. The PDA normally uses a touch-control screen along with a pen instead of keys. Nevertheless, the input speed using the touch-control screen has its limits. Because of this, some manufacturers have invented external keyboards for mobile phones or PDAs. However, Palm-series PDAs or mobile phones of different models or from different manufacturers have connection ports of different specifications PDAs. In this case, the user has to prepare a corresponding keyboard for each device. Since a user may carry both a mobile phone and a PDA at the same time, s/he then needs to carry two external keyboards for them. Furthermore, modern mobile phones can be connected with external handwriting boards, but mobile phones from different manufacturers have different connection ports. Therefore, external handwriting boards have to have specific connectors. If the user changes his or her mobile phone, the original external handwriting board may not be used on the new mobile phone and the user may be forced to purchase a new one.

### SUMMARY OF THE INVENTION

An object of the invention is to provide a connecting device that can be used for connection ports of different specifications so that an external peripheral device can form electrical communications with different electronic devices.

The disclosed connecting device includes a connection base and a connector. The connection base is mounted on the external peripheral device. A plurality of electrical pins is provided on the connection base. One end of the connector can be plugged into the connection base and form electrical communication with the electrical pins. The other end of the connector is designed according to the specifications of the connection port of the corresponding electronic device. For different connection port specifications, a number of modularized connectors is provided for users to select the one that matches the electronic device and plug it into the connection base. The connector is then plugged into the connection port of the electronic device, thus forming electrical communication between the external peripheral device and the electronic device. When connecting the external peripheral device to another electronic device, one only needs to change to another connector that matches the specifications of the electronic device.

### BRIEF DESCRIPTION OF THE DRAWINGS

The invention will become more fully understood from the detailed description given hereinbelow. However, the following description is for purposes of illustration only, and thus not limitative of the invention, wherein:

FIG. 1 is a schematic view showing the disclosed connecting device separated from a PDA;

FIG. 2 is a schematic view showing the disclosed connecting device connected to a PDAs;

FIG. 3 is a cross-sectional view of the disclosed connecting device connected to a PDAs;

FIGS. 4A and 4B show another embodiment of the invention; and

FIG. 5 is a schematic view of a negative logic circuit of yet another embodiment.

### DETAILED DESCRIPTION OF THE INVENTION

The disclosed connecting device is installed on an external peripheral device to establish electrical communication between the external peripheral device and an electronic device for electrical signal transmission. The electronic device here refers to a small portable device such as a mobile phone or a PDAs (Personal Digital Assistants). The external peripheral device refers to an extension device such as an external handwriting board or an external keyboard that can connect to the mobile phone or PDAs. The following description simply provides an explicit embodiment of the invention, but should not be used to limit the scope of the invention.

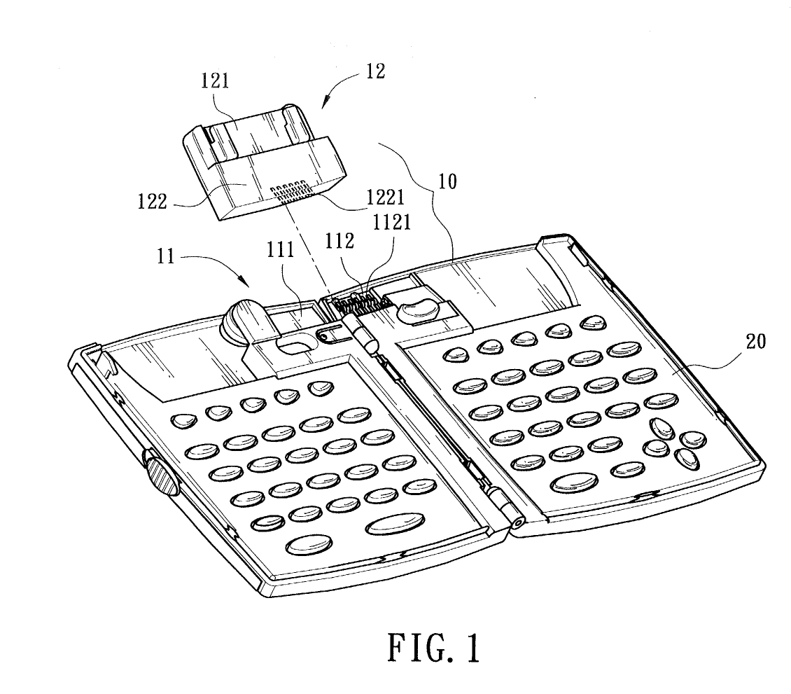

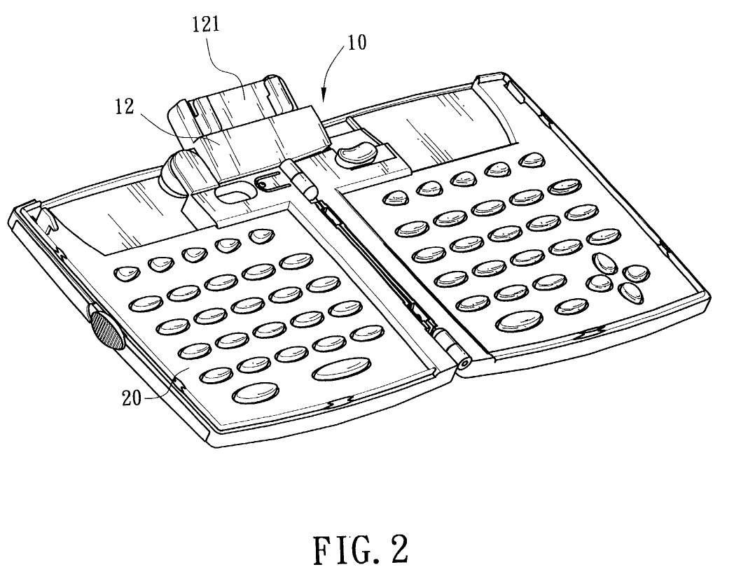

As shown in FIGS. 1 and 2, the connecting device 10 is installed on an external peripheral device 20 (an external keyboard is shown in the drawings). The connecting device 10 includes a connection base 11 and a connector 12. The connection base 11 is directly installed at a proper position on the external peripheral device 20. It has a slot 111 accommodating a plurality of electrical pins 112 that can establish electrical communication with a circuit board (not shown) inside the external peripheral device 20. An elastic part 1121 is provided at a proper position around the electrical pins 112.

The connector 12 is a singularly modularized component. It can be selectively plugged and mounted onto the slot 111 by locking, for example (not shown in the drawing), or taken off the slot 111. One end of the connector 12 is an external terminal 121 designed according to the connection port (not shown) of the electronic device to be connected. The external terminal 121 can be a P-type terminal (the terminal for Palm-series PDAs, as shown in the drawing) or an I-type terminal (the terminal for iPAQ-series PDAs). The other end of the connector 12 is an internal terminal 122 with a plurality of electrical connection points 1221 corresponding to the electrical pins 112.

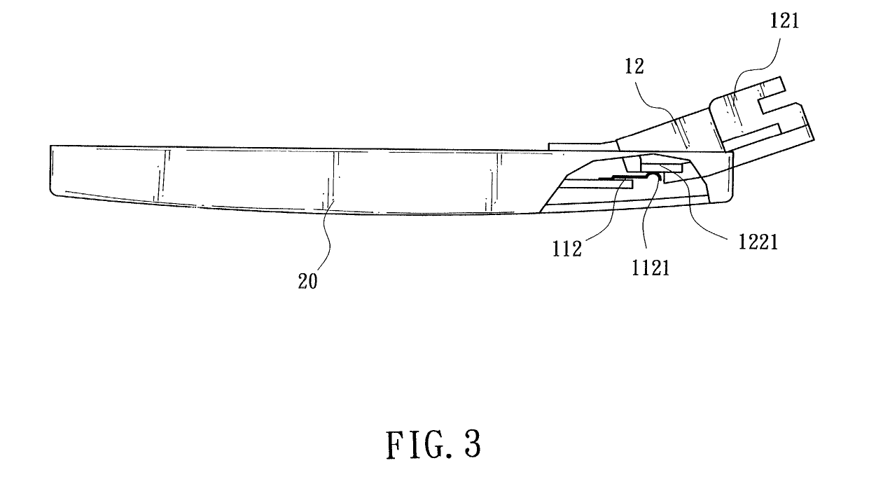

As shown in FIG. 3, the user selects a connector 12 that matches the electronic device according to the specifications of the connection port. The connector 12 is plugged into the slot 111 of the connection base 11 so that the electrical connection points 1221 of the internal terminal 122 and the electrical pins 112 inside the slot 111 form electrical communication. Through the design of the elastic part 1121, the electrical pins 112 are kept in contact with the electrical connection points 1221. The external peripheral device 20 can be plugged into the connection port of the electronic device using the external terminal 121 of the connector 12 so that the external peripheral device and the electronic device form electrical communication.

When the external peripheral device 20 connects to another electronic device, the external terminal 121 of the connector 12 can be directly connected to the connection port of the electronic device if they match. If they do not match, then the original connector 12 is unplugged and a matching connector 12 is selected and mounted on the connection base 11. The connector can then be connected to the connection port of the electronic device. Consequently, the same external peripheral device 20 can be used on different electronic devices.

For manufacturers, the disclosed modularized design can solve production, design, and stocking problems as well as lower production costs. Even if a user carries multiple electronic devices, he or she only needs to prepare an external peripheral device 20 and connectors 12 for the electronic devices. Therefore, the user does not need to have several external peripheral devices 20.

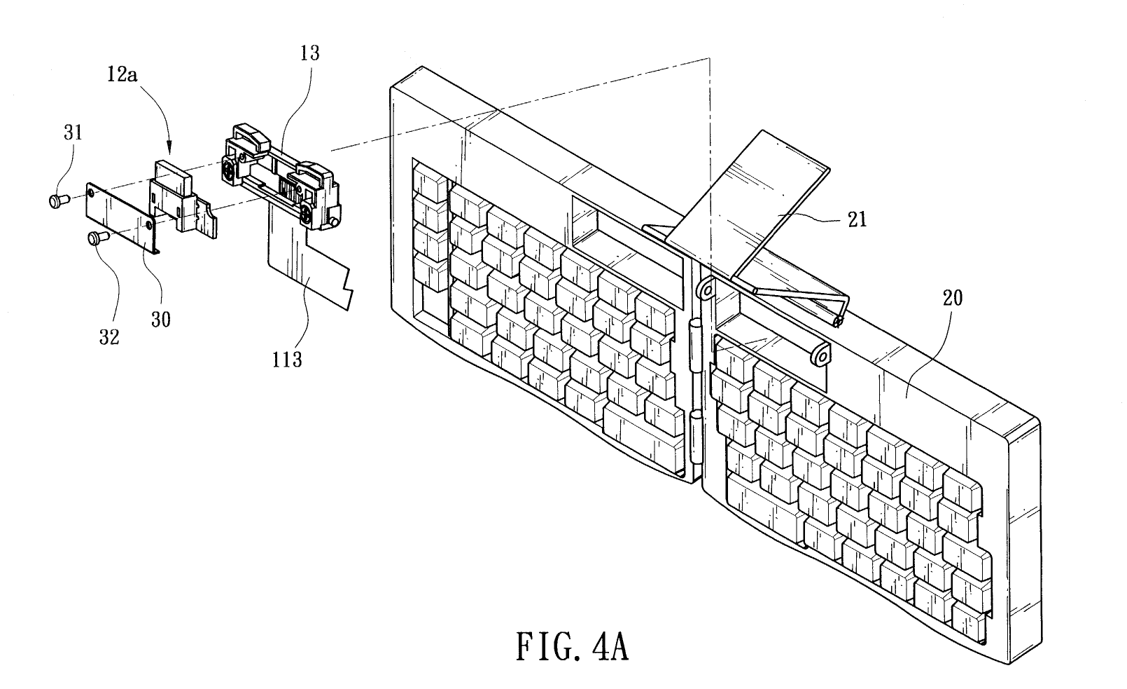

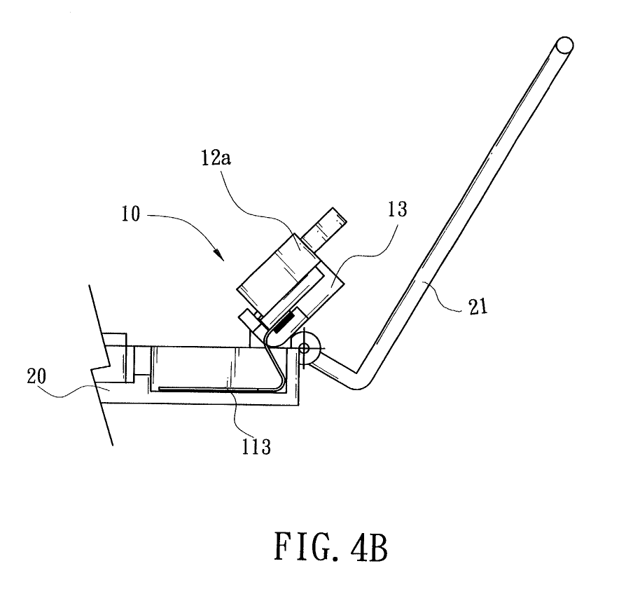

FIG. 4A shows another embodiment of the invention. The electrical pins 112 on the connection base 11 can be substituted by a soft connector cable 113. The connection base 11 is provided with a rotational base 13. The electrical connection points of the soft connector cable 113 are mounted on the rotational base 13. The connector 12a (an I-type connector is shown in the drawing) is installed at the location on the rotational base 13 corresponding to the soft connector cable 113. A clasping plate 30 along with connector bolts 31 and 32 is used to connect the connector 12a to the connection base 11. The connector 12a is thus fixed on the rotational base 13 and electrically connected with the soft connector cable 113.

As shown in FIG. 4B, the user can select the proper connector 12a to put on the rotational base 13, forming electrical communication with the soft connector cable 113. The clasping plate 30 is then used to fix the connector 12a in order to connect the external peripheral device 20 to the connection port of the electronic device. Therefore, the connector 12a can be accommodated into the connection base 11 or rotated to the side of the connection base 11 for connecting with the electronic device. A support base 21 is further installed at a position on the external peripheral device 20 that corresponds to the connection base 11. When the external peripheral device 20 is put on a table, the electronic device can be placed on the support base 21 to form electrical communication with the connector 12a. The user can thus more conveniently use the external peripheral device 20. When there are different electronic devices, the user can still use the same external peripheral device by merely taking off the clasping plate 30 and replacing the connector 12a with a proper one.

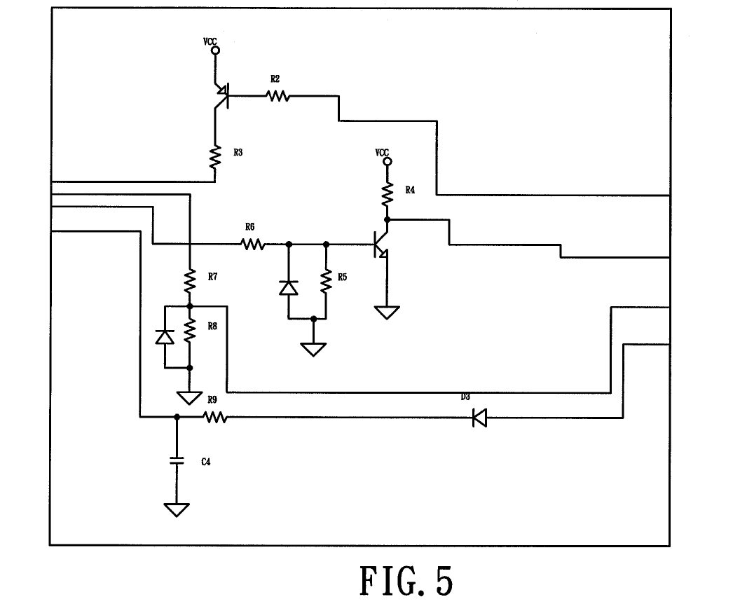

In accordance with the disclosed connecting device, the connection ports in some electronic devices use negative logic circuits. The invention further installs the negative logic circuit in the connector 12. A negative logic circuit diagram is shown in FIG. 5. In addition to different connectors 12 for connection ports of different specifications, the invention also provides connectors that match with different connection port logic circuits. For example, if the connection port of the electronic device has a negative logic circuit, then a connector 12 with a negative logic circuit can be used to increase the application of the external peripheral device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A connecting device installed on an external peripheral device for providing electrical communications between the external peripheral device and an electronic device with a connection port of a specific specification, which comprises:
a connection base, which is installed on the external peripheral device and has a plurality of electrical pins for forming electrical communications with the external peripheral device; and
a connector, which can be selectively connected with and departed from the connection base and has an internal terminal for forming electrical communications with the electrical pins and an external terminal that matches and forms electrical communications with the connection port of the electronic device.

2. The connecting device of claim 1, wherein the external peripheral device is a keyboard.

3. The connecting device of claim 1, wherein the external peripheral device is a hand-written board.

4. The connecting device of claim 1, wherein the electronic device is a mobile phone.

5. The connecting device of claim 1, wherein the electronic device is a PDAs (Personal Digital Assistants).

6. The connecting device of claim 1, wherein the connection base has a slot for accommodating the connector and the electrical pins are provided inside the slot.

7. The connecting device of claim 1, wherein the electrical pins further include an elastic part to keep the electrical pins in electrical contact with the internal terminal.

8. The connecting device of claim 1, wherein the electrical pins are replaced by a soft connector cable.

9. The connecting device of claim 1, wherein the connector is selected to match with the specification of the connection port of the electronic device.

10. The connecting device of claim 1, wherein the connection base is further provided with a pivotally installed rotational base and the connector is combined with the rotational base using a clasping plate.

11. The connecting device of claim 1, wherein the connector further contains a negative logic circuit for matching with the connection port of the electronic device that has a negative logic circuit.
